(19) United States
(12) Patent Application Publication
(10) Pub. No.: US 2005/0186238 A1
(43) Pub. Date: Aug. 25, 2005

(54) Universal insect repellant enclosure

(75) Inventors: Gene Ozawa, San Jose, CA (US); Osamu Igarashi, Zama (JP); Noriyoshi Komiyama, Sagamihara (JP)

Correspondence Address: CARR & FERRELL LLP, 2200 GENG ROAD, PALO ALTO, CA, 94303, US

(73) Assignee: Nix, Inc.

(21) Appl. No.: 11/112,067

(22) Filed: Apr. 22, 2005

Related U.S. Application Data
(63) Continuation-in-part of application No. 10/693,079, filed on Oct. 23, 2003.

(30) Foreign Application Priority Data
Jun. 3, 2003 (JP) 2003-158574

(51) Int. Cl. A01M 1/20; A01N 25/00

(52) U.S. Cl. 424/405

(57) ABSTRACT

A universal enclosure insect repellant enclosure is disclosed. An enclosure wherein at least one portion of the enclosure is comprised of a material incorporated with an insect repellant is provided. The enclosure may also comprise at least one opening. The at least one opening may include a door or a lid.

### CROSS-REFERENCE TO RELATED APPLICATIONS

The present application is a continuation-in-part and claims the benefit and priority of U.S. patent application Ser. No. 10/693,079 filed Oct. 23, 2003 and entitled “Insect Repelling Resin System and Insect Repelling Method Using the Same;” U.S. patent application Ser. No. 10/693,079 claims the priority and benefit of Japanese patent application number 2003-158574, filed Jun. 3, 2003 and entitled “Insect Repelling Resin System and Insect Repelling Method Using the Same,” both of which are herein incorporated by reference.

### BACKGROUND OF THE INVENTION

1. Field of the Invention

The present invention relates generally to insect repellants, and more particularly to an insect repellant universal enclosure.

2. Description of Related Art

Conventionally, many insect repelling resin products are designed for agricultural use. Some products may utilize a flared skirt-shaped resin product containing an arthropod repellant. When these products are mounted on stems of plants bearing fruits, nuts, flowers, etc., the additive effect of the skirt shape and the repellent prohibits or deters harmful insect, in particular fire ants or red imported fire ants (“RIFA”), that climb from the ground up the stem from surpassing the product and reaching the fruit, nuts, flowers on the stem. Thus, damage to agricultural products can be prevented.

However, damage caused by insects is not limited to agricultural products, but extends to houses, vehicles, and other apparatuses that require hermetical sealability. For example, insects, such as ants, may penetrate apparatuses that are installed outdoors (e.g., traffic signal controllers) or apparatuses used outdoors (e.g., automobiles, motorcycles, tractors). Further, there have been numerous reports of such insects building nests in apparatuses installed outdoors in southern parts of the United States.

One would not normally expect insects to gather in outdoor apparatuses such as traffic signal controllers since there is no food inside. However, wind and rain does not affect an inside of these outdoor apparatuses, and a somewhat constant temperature is maintained within these apparatuses even during winter seasons. Further, the insects may use the apparatus to shelter themselves from foreign enemies. Thus, the outdoor apparatus likely provides a comfortable and safe environment for the insects.

Disadvantageously, penetration of the insects into the outdoor apparatuses may cause malfunctions in the outdoor apparatuses. Typically, insects such as ants or similar insects with small body sizes are able to penetrate into the outdoor apparatus even from a small gap. Once inside the outdoor apparatus, the insects may penetrate a control circuit via wiring. Often time, most of the insects die within the outdoor apparatus since the insects are not able to exit the outdoor apparatus. Consequently, a hormone-lie substance is discharged from the dead insect, and this substance becomes a factor in attracting further insects. The attracted insects similarly penetrate into the control circuit via the small gap and wiring of the outdoor apparatus. Insects that are not able to exit from the outdoor apparatus will continue to die within the outdoor apparatus. As this process repeats, the control circuit may eventually short circuit or become insulated and results in the malfunction of the outdoor apparatus.

A conventional method of repelling insects comprises spraying a liquid insect repellent or placing a solid insect repellant in or around the apparatus. However, these methods typically only have an effect of several days to several weeks. Further, these methods are not suitable for an apparatus, such as a traffic signal controller, used for an extended period of time (e.g., five to tens years) since a long-term insect repellant effect is required. It would be time consuming and non-economical to perform these conventional methods every few weeks. Additionally, spraying liquid insect repellent may cause damage to sensitive outdoor apparatuses.

Alternatively, the penetration of insects may be prevented by employing a device to heat the insect repellent, such as with a heater. The heating process will gradually discharge the insect repellant over time. However, since space is required for installing the heating device inside the apparatus, there are limitations for using such a method in existing apparatuses (i.e., the apparatuses are not designed with enough space for the heating device). Additionally, this method sometimes results in relatively expensive installation costs.

Therefore, there is a need for a universal insect repellant enclosure.

### SUMMARY OF THE INVENTION

A universal insect repellant enclosure is provided. In one embodiment, a method for creating the universal insect repellant enclosure is provided. An insect repellant is incorporated into one or more portions of a material capable of sustaining release of the insect repellant over a period of time. The one or more portions of the material are then utilized to create an enclosure.

In a universal enclosure according to one embodiment, an enclosure wherein at least one portion of the enclosure is comprised of a material incorporated with an insect repellant is provided.

### BRIEF DESCRIPTION OF THE DRAWINGS

FIG. 1 illustrates an exemplary universal enclosure;

FIG. 2 illustrates an exemplary door associated with the universal enclosure;

FIG. 3 illustrates the universal enclosure having one or more cut-out portions;

FIG. 4 illustrates a collapsible universal enclosure;

FIG. 5 illustrates an exemplary canister universal enclosure; and

FIG. 6 illustrates an exemplary universal control box.

### DESCRIPTION OF EXEMPLARY EMBODIMENTS

An insect repellant enclosure comprises a multipurpose enclosure for protecting contents associated with the enclosure. The entire enclosure or portions of the enclosure may be comprised of an insect repelling resin product. The insect repelling resin product includes a material, such as plastic, that incorporates a pesticide within the material, itself. In exemplary embodiments, the repellant within the material is effective for 3 to 10 years. Alternatively, the pesticide within the enclosure may be effective for any length of time in accordance with various embodiments.

In some embodiments, a space is located at a partition (i.e., partitioning an inside and outside of the object) through which the insects penetrate into the object. By providing the insect repelling resin as part of the enclosure in these areas, the insect repellant is gradually discharged and the penetration of the insects into the enclosure is deterred. Thus, damage to the contents of the enclosure can be prevented. Additionally, one or more portions of the enclosure may be comprised of the material having the insect repellant, so the enclosure can be made for varying situations.

The insect repellant incorporated into the enclosure may comprise a compound having an insect repelling effect, an insect killing effect, an anti-feeding effect, a growth-control effect, or any other effect detrimental to the insects. Specifically, the insect repellant may comprise pyrethroid compounds, carbamate compounds, organic phosphorous compound and isomers, derivatives and affinities thereof, and other compounds having an effect of controlling growth of insects.

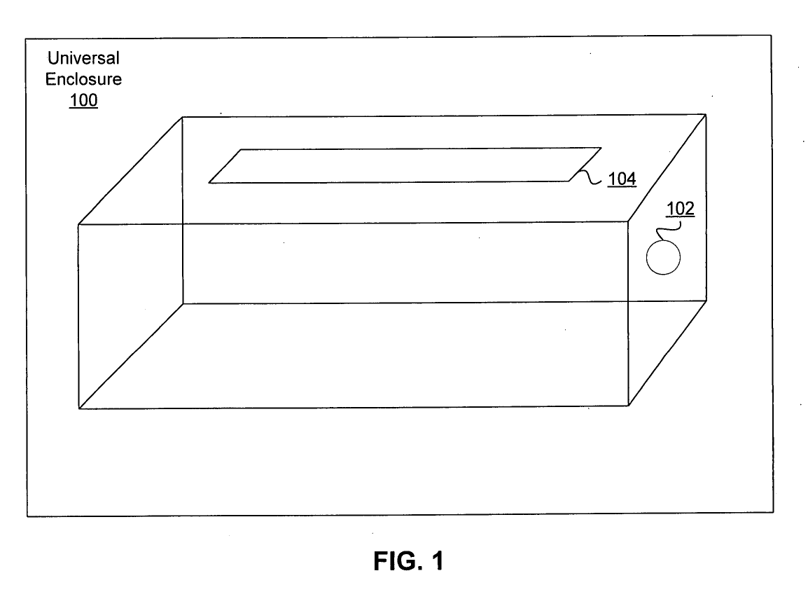

Turning now to FIG. 1, an exemplary universal enclosure 100 is shown. The universal enclosure 100 may be comprised entirely of material having the insect repellant incorporated into the material or portions of the universal enclosure 100 may be comprised of the material incorporating the insect repellant. Although the universal enclosure 100 shown in FIG. 1 is illustrated as a rectangular box, any shape for the universal enclosure 100 is within the scope of various embodiments. For instance, the universal enclosure 100 may be square, oval, tubular, and so forth.

The universal enclosure 100 may include an electrical circuit enclosure, a control box enclosure, such as a traffic control box, a sprinkler system control box, and so forth. The universal enclosure 100 may include any type of content for any purpose in accordance with various embodiments.

One or more openings may be included in the universal enclosure 100, such as the opening 102 shown in FIG. 1. The opening(s) 102 may exist for allowing contents to be inserted into and removed from the universal enclosure 100. For instance, the opening(s) 102 may allow for the ingress and egress of electrical wires. While the opening(s) 102 is shown as a round opening, the opening(s) 102 may comprise any shape.

In one embodiment, one or more of the universal enclosure(s) 100 is manufactured according to specifications for conventional enclosures in a particular industry. For instance, the universal enclosure 100 may be manufactured, with the insect repellant incorporated into the universal enclosure 100, in three different sizes commonly used by electricians in the electrical industry.

In another embodiment, the universal enclosure 100 may be manufactured according to customized specifications for the universal enclosure 100. For example, a particular entity may specify dimensions needed for the universal enclosure 100 (e.g., stoplight). The particular entity may also specify what portions of the universal enclosure 100 should incorporate the insect repellant to best deter insects from penetrating the universal enclosure 100 (e.g., light bulb openings of the stoplight). However, the universal enclosure 100, may also be customized in a manner that is designed to best avoid the infiltration of insects. As discussed herein, in one embodiment, the entire universal enclosure 100 is comprised of a material incorporating the insect repellant.

A door 104 may also be included as part of the universal enclosure 100. The exemplary door 104 may be attached to the universal enclosure 100 by one or more hinges. Alternatively, any manner of attaching the door 104 is within the scope of various embodiments. For instance, the door 104 may slide along tracks for opening and closing. The door 104 may be any size relative to the universal enclosure 100. In one embodiment, the door 104 comprises an entire side of the universal enclosure 100. Further, more than one door 104 may be provided on the exemplary universal enclosure 100.

The door 104 may be utilized to place or access contents inside the universal enclosure 100. As discussed herein, any type of contents may be placed inside the universal enclosure 100. The door 104 of the universal enclosure 100 may be designed according to specifications for the door 104 size needed for a particular industry and/or according to the door 104 size best suited to allow for contents to be placed inside of the universal enclosure 100, to be taken out of the universal enclosure 100, and/or to repel the insects from seams around the door 104 of the universal enclosure 100.

In one embodiment, the door 104 is not capable of opening and closing. The door 104 may be an attachment that is removed from the universal enclosure 100 to create a permanent opening in the universal enclosure 100. The opening created by removing the door 104 may then be utilized to fit the universal enclosure 100 over, around, etc. contents to be enclosed inside of the universal enclosure 100. The sides adjacent to the door 104 may be comprised of the material having the insect repellant incorporated therein, and thus, the insects may be repelled from entering the area where the door 104 is removed.

Although the door 104 illustrated in FIG. 1 is rectangular in shape, the door 104 may be any shape in accordance with various embodiments. For example, the door 104 may be square, round, oval, triangular, and so on. In one embodiment, the universal enclosure 100 includes only the door 104, which may be hinged or permanently removed, and not any other of the opening(s) 102.

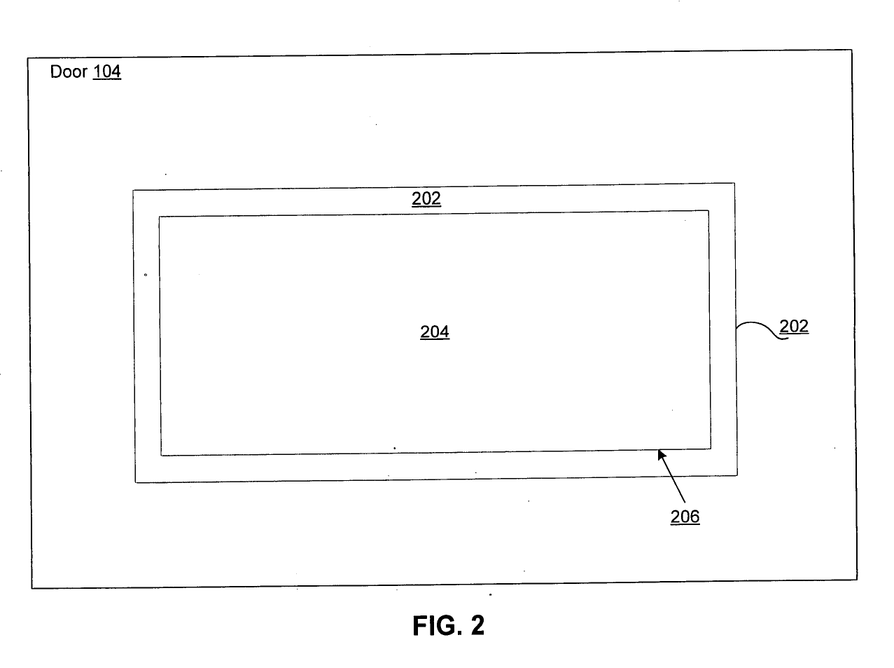

Referring now to FIG. 2, an exemplary door 104 associated with the universal enclosure 100 according to one embodiment is shown. The door 104 may have a frame 202 and a protrusion 204 associated with the inside of the door 104. The frame 202 and/or the protrusion 204 may be comprised of the material having the insect repellent incorporated into the material.

In one embodiment, the frame 202 is comprised of the insect repellant material, while the protrusion 204 is comprised of a material without the insect repellant. Because the insects that attempt to enter the universal enclosure 100 via the door 104 encounter the outer edge that is the frame 202 of the door 104 first, the frame 202 comprised of the material incorporating the insect repellant may be sufficient to repel insects from invading the universal enclosure 100 through the door 104.

Because the protrusion 204 extends inward from the frame 202, the protrusion 204 may have an edge 206 in one embodiment. The edge 206 may be comprised of the material incorporating the insect repellant. The insects that attempt to penetrate the universal enclosure 100 through the door 104 likely have to traverse the edge 206 of the protrusion 204 in order to gain access to the universal enclosure 100 contents. Accordingly, if the edge 206 of the protrusion 204 is made of the material incorporating the insect repellant, the insects may be deterred from entering the universal enclosure 100 through the doorway.

As discussed herein, the entire door 104 may be comprised of the material incorporating the insect repellant. In some embodiments, as discussed herein, the entire universal enclosure 100 is comprised of the material incorporating the insect repellant.

In one embodiment, an area inside of the frame 202 of the door 104 may recede from the frame 202, rather than protruding outward from the frame 202. The areas of the universal enclosure 100 adjacent to the frame 202 and/or other areas of the door 104 may also be comprised of the material incorporating the insect repellant.

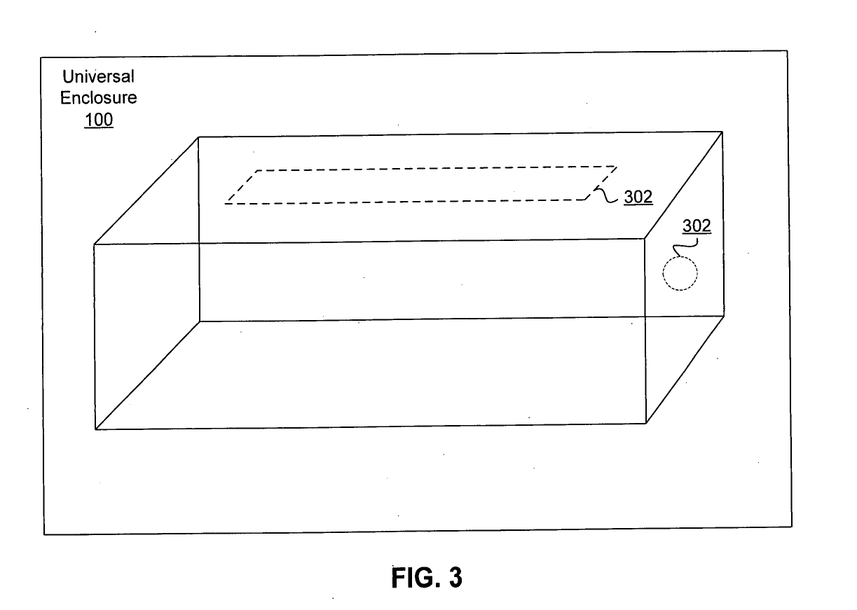

Turning now to FIG. 3, a universal enclosure 300 having one or more cut-out patterns 302 is shown in accordance with one embodiment. The cut-out patterns 302 may mark areas where members of a particular industry normally require openings in the universal enclosure 100. A user may choose not to remove one or more of these cut-out patterns 302.

The cut-out patterns 302 may be removed by applying pressure to the material surrounded by the cut-out patterns 302, however, any manner of removing the cut-out patterns 302 may be utilized in accordance with various embodiments. In exemplary embodiments, the cut-out patterns 302 are perforated to facilitate the removal of the cut-out pattern 302.

In exemplary embodiments, the areas adjacent to the cut out patterns 302, within the universal enclosure 100, are comprised of the material incorporating the insect repellant. Accordingly, when the insects attempt to infiltrate the universal enclosure 100 through the areas once covered by the cut-out patterns 302, the insect repellant in the material comprising the adjacent areas deters the insects.

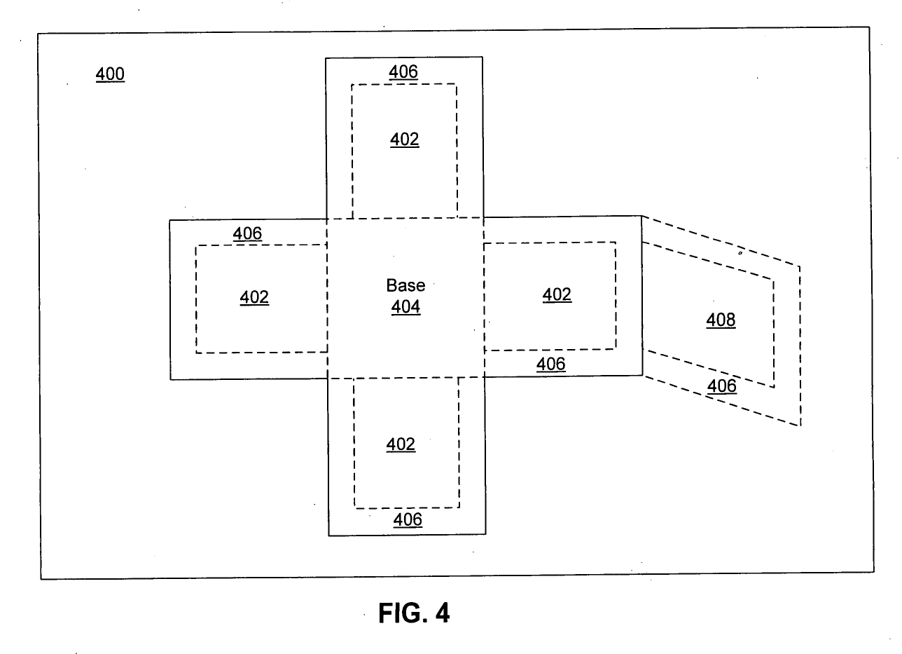

Referring to FIG. 4, a collapsible universal enclosure 400 is shown. The collapsible universal enclosure 400 may be made entirely of the material incorporating the insect repellant. Portions of the collapsible universal enclosure 400 may be made of the material incorporating the insect repellant.

The collapsible universal enclosure 400 may include a plurality of sides 402. The collapsible universal enclosure 400 also includes a base 404. Although FIG. 4 indicates four sides 402 and a square base 404, the collapsible universal enclosure 400 may have a triangular base 404 and three sides 402. Alternatively, any shape of the base 404 and the sides 402 are within the scope of various embodiments. For instance, the base 404 may be circular and the sides 402 may include a curvature.

The sides 402 may be of any size and/or length. For instance, if the base 404 is rectangular, two of the sides 402 may be shorter, while the remaining two sides 402 are longer to accommodate the rectangular shape of the base 404.

When the sides 402 of the collapsible universal enclosure 400 are erected, the perimeters 406 associated with each of the sides 402 come into contact with each other. In exemplary embodiments, the perimeters 406 of each of the sides 402 are comprised of the material incorporating the insect repellant. Accordingly, at each seam of the collapsible universal enclosure 400, where the insects may elect to enter the collapsible universal enclosure 400, insect repellant is present to deter the insects from entry.

A lid (not shown) may optionally be provided in order to close off the collapsible universal enclosure 400. The lid may be made of the material incorporating the insect repellant, or a portion of the lid may be made of the material incorporating the insect repellant, such as the portions of the lid coming into contact with the perimeter 406 of each of the sides 402. In one embodiment, the collapsible universal enclosure 400 is left open at one end for fitting around contents to be enclosed.

In one embodiment, one of the sides 402 includes an additional flap 408 for acting as a lid closure for the collapsible universal enclosure 400. The flap 408 may be made entirely of the material incorporating the insect repellant or a portion of the flap 408 may be made of the material incorporating the insect repellant. In one embodiment, the perimeter 406 of the flap 408 is made of the material incorporating the insect repellant. Accordingly, the portions of the flap 408 that come into contact with the perimeter 406 of each of the sides 402 form insect repellant seams.

In another embodiment, one or more of the sides 402 include the flap 408 for creating a closure of the collapsible universal enclosure 400 or for providing a partial closing of one end of the collapsible universal enclosure 400. For example, the flap 408 for each of the sides 402 may extend out less than half the distance of the base 404. Thus, the flaps 408 for each of the sides 402, when erected, may form an opening at the end opposite the base 404.

The base 404 may be comprised of the material incorporating the insect repellant entirely or at the perimeter of the base 406. However, any portion of the base 404 may be comprised of the material incorporating the insect repellant.

In one embodiment, the base 404 and/or one or more of the sides 402 includes one or more openings, such as the opening(s) 102 discussed in FIG. 1. Any type of openings may be included. In exemplary embodiments, the material incorporating the insect repellant is utilized to create the base 404 and the sides 402 adjacent to the one or more openings. Alternatively, as discussed herein, the sides 402 and/or the base 404, as well as a lid, may be made entirely of the material incorporating the insect repellant.

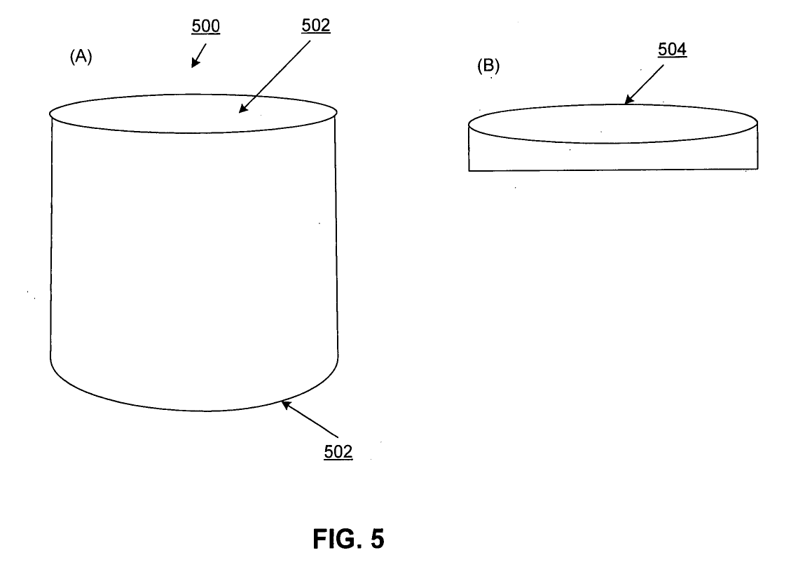

Turning now to FIG. 5, an exemplary canister universal enclosure 500 is shown in accordance with one embodiment. As discussed herein, any universal enclosure may be made entirely of the material incorporating the insect repellant or may have one or more portions of the universal enclosure made of the material incorporating the insect repellant. Similarly, the canister universal enclosure 500 may be made entirely of the material incorporating the insect repellant or portions of the canister universal enclosure 500 may be made of the material incorporating the insect repellant.

The canister universal enclosure 500 may be closed or open at either of the ends 502. If one of the ends 502 is closed, while the other end 502 is open, the open end 502 may remain open for fitting the canister universal enclosure 500 around contents.

The canister universal enclosure 500 is made of the material incorporating the insect repellant at the perimeter along the ends 502 in exemplary embodiments. Accordingly, when the insects attempt to enter the canister universal enclosure 500 through the seams at the ends 502, the insects are deterred from entry. Perimeters associated with the ends 502, or the ends 502 in their entirety, may also be made of the material incorporating the insect repellant. Accordingly, the seams, in exemplary embodiments, at the ends 502 are comprised of the material incorporating the insect repellant.

A lid 504 may also be provided for the canister universal enclosure 500. A perimeter associated with the lid 504 may be made of the material incorporating the insect repellant or the entire lid 504 may be comprised of the material incorporating the insect repellant. Accordingly, when the lid 504 is adjoined to the canister universal enclosure 500, the seams are repellant against the insects.

In one embodiment, one or more openings, such as the opening(s) 102 discussed in FIG. 1, are included in the canister universal enclosure 500 and/or one or more of the ends 502. The areas adjacent to the one or more openings are made of the material incorporating the insect repellant in exemplary embodiments.

Although the canister universal enclosure 500 is illustrated as a single piece in FIG. 5, the canister universal enclosure 500 may be comprised of any number of pieces. For instance, two half circles may come together via hinges to form the canister universal enclosure 500. Perimeters associated with the two half circles, or any other pieces, are comprised of the material incorporating the insect repellant in exemplary embodiments. Any manner of fastening separate pieces of the canister universal enclosure 500, or any other universal enclosure discussed herein, may be employed in accordance with various embodiments.

As discussed herein, any of the universal enclosures may be manufactured to include any of the features discussed herein. The universal enclosures may be customized to include any types of features, such as doors, openings, cut-outs, flaps, lids, and/or any other features. The universal enclosures may be comprised entirely of the material incorporating the insect repellant or portions of the universal enclosure may be comprised of the material incorporating the insect repellant. The material incorporating the insect repellant may be separate and joined with the material not incorporating the insect repellant. Alternatively, the two different materials may be manufactured as one piece, enclosure, or otherwise having some areas with the insect repellant and other areas without the insect repellant.

The material incorporating the insect repellant discussed herein may comprise at least one type of resin to structure the material. The at least one type of resin may comprise polyacetal resin, polyamide resin, acrylonitrile butadiene styrene copolymer (ABS resin), polystyrene (PS), polyethylene (PE), polypropylene (PP), polycarbonate (PC), vinyl chloride resin (PVC), polybutylene terephthalate (PBT), polyethylene terephthalate (PET), polyphenylene oxide (PPO), and thermoplastic elastomer. In some embodiments, the various shapes of the universal enclosures are created via molding techniques such as, but not limited to, injection molding.

A material having an effect of retaining the insect repelling components in the resin and adding sustained-release of the insect repellant is utilized in exemplary embodiments. Examples of such compounds having sustained-release properties comprise sulfa derivative, sulfonic ester derivative, carboxylic amide derivative, and carboxylate ester derivative. By including the sustained-release compound in the material, the insect repellant will be discharged from the resin over an extended period of time. In one embodiment, the insect repelling resin product is able to maintain a repelling effect for more than ten years.

The composition of the various components (e.g., resin, insect repellant, material having sustained-release properties, etc.) of the insect universal enclosures varies in accordance with the selected components and the desired length of time (i.e., number of years) to maintain the insect repelling effect. According to exemplary embodiments, the composition may comprise a mix of 100 weight parts of resin, 0.01 to 30 weight parts of the insect repellant, and 2 to 60 weight parts of the material having sustained-release properties. Alternative embodiments may have a different combination of the components.

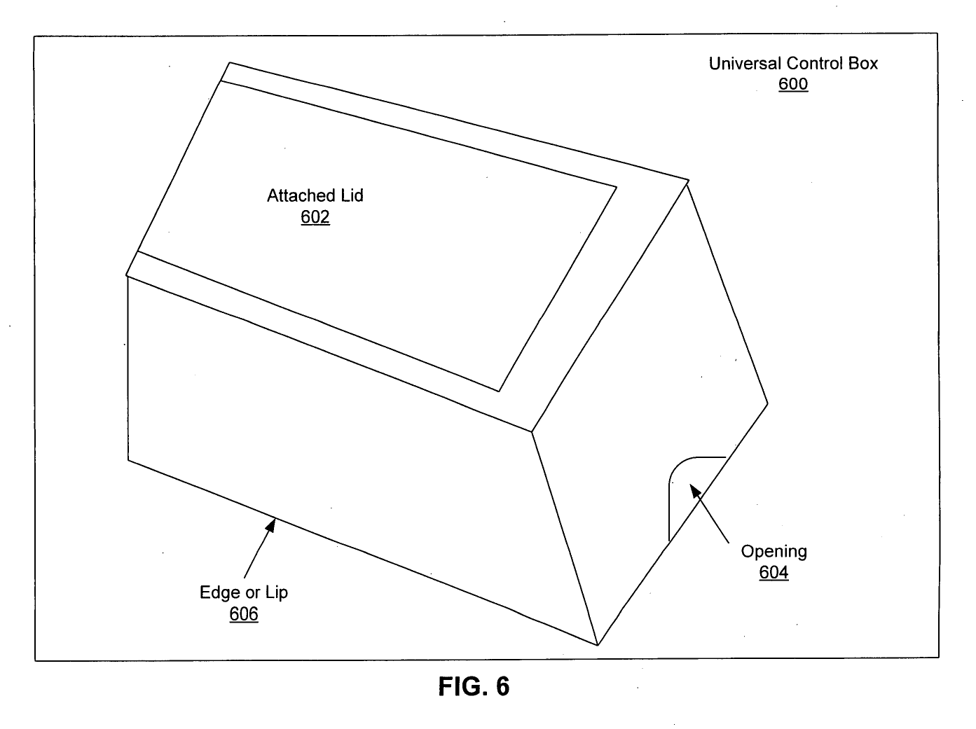

Turning now to FIG. 6, an exemplary universal control box 600 is illustrated according to one embodiment. The universal control box 600 may include an attached door 602 and an opening 604. The underside of the universal control box 600 is open or otherwise uncovered according to an exemplary embodiment. However, the underside of the universal control box 600 may be closed, partially closed, and so on according to one embodiment.

The universal control box 600 may be fitted over contents to be surrounded by the universal control box 600. Once the universal control box 600 is fitted over the contents, the opening 604 and/or the attached door 602 may be utilized to access the contents. Although FIG. 6 shows the opening 604 associated with one side of the universal control box 600, one or more openings 604 may be associated with the side of the universal control box 600 and/or any other sides of the universal control box 600.

In one embodiment, an edge or lip 606 of the universal control box 600 is formed to attach to a receiver piece. For example, the edge or lip 606 of the universal control box 600 may snap onto a valve plate conditioned to receive the universal control box 600. Any type of receiver may be provided according to one embodiment. Further, any type of attachment mechanism may be provided, such as tongue and groove, adhesive, fasteners, and so on.

While various embodiments have been described above, it should be understood that they have been presented by way of example only, and not limitation. For example, any of the elements associated with the insect repellant enclosures may employ any of the desired functionality set forth hereinabove. Thus, the breadth and scope of a preferred embodiment should not be limited by any of the above-described exemplary embodiments.

1. A system for repelling insects comprising:
an enclosure configured to encompass at least one item to be protected from insects, wherein at least one portion of the enclosure is comprised of a material incorporated with an insect repellant.

2. The system recited in claim 1, wherein the enclosure comprises an electrical circuit enclosure.

3. The system recited in claim 1, wherein the enclosure comprises a control box.

4. The system recited in claim 1, wherein the material is capable of sustaining release of the insect repellant over a period of time.

5. The system recited in claim 1, wherein the material incorporates at least one of a sulfa derivative, a sulfonic ester derivative, a carboxylic amide derivative, and a carboxylate ester derivative.

6. The system recited in claim 1, wherein the material with the insect repellant comprises at least one of a polyacetal resin, a polyamide resin, a acrylonitrile butadiene styrene copolymer (ABS resin), a polystyrene (PS), a polyethylene (PE), a polypropylene (PP), a polycarbonate (PC), a vinyl chloride resin (PVC), a polybutylene terephthalate (PBT), a polyethylene terephthalate (PET), a polyphenylene oxide (PPO), and a thermoplastic elastomer

7. The system recited in claim 1, wherein the enclosure comprises at least one opening.

8. The system recited in claim 7, wherein the material incorporated with the insect repellant is located along a perimeter of the at least one opening.

9. The system recited in claim 7, further comprising one or more lids for the at least one opening.

10. The system recited in claim 1, wherein the enclosure comprises at least one door.

11. The system recited in claim 10, wherein the material incorporated with the insect repellant is located along a perimeter of the at least one door.

12. The system recited in claim 1, wherein the at least one portion comprises one or more perimeters associated with the enclosure.

13. A universal enclosure for repelling insects comprising:
an enclosure;
one or more sides having perimeters associated with the enclosure; and
a material incorporated with an insect repellant coupled to the perimeters of the one or more sides.

14. The system recited in claim 13, further comprising at least one door associated with the enclosure.

15. The system recited in claim 13, further comprising at least one opening associated with the enclosure.

16. A universal enclosure for repelling insects comprising:
an enclosure having at least one opening;
a material incorporating an insect repellant comprising areas of the enclosure adjacent to the at least one opening.

17. The universal enclosure recited in claim 18, wherein the material is capable of sustaining release of the insect repellant over a period of time.

18. A method for creating a universal enclosure for repelling insects, comprising:
incorporating an insect repellant into one or more portions of material capable of sustaining release of the insect repellant over a period of time; and
utilizing the one or more portions of the material in creating an enclosure.

19. The method recited in claim 18, further comprising forming the enclosure utilizing a molding technique.
